(19) United States
(12) Patent Application Publication
(10) Pub. No.: US 2010/0320637 A1
(43) Pub. Date: Dec. 23, 2010

(54) METHOD OF MAKING POLYMER/NATURAL FIBER COMPOSITE PELLET AND/OR A COUPLING AGENT/NATURAL FIBER PELLET AND THE PELLET MADE BY THE METHOD

(76) Inventor: Antal Boldizar, Kinnahult (SE)

Correspondence Address: HARNESS, DICKEY & PIERCE, P.L.C., P.O. BOX 8910, RESTON, VA, 20195, US

(21) Appl. No.: 12/735,198

(22) PCT Filed: Dec. 19, 2008
(86) PCT No.: PCT/SE2008/051526

§ 371 Date: Aug. 27, 2010

(30) Foreign Application Priority Data
Dec. 21, 2007 (SE) 0702851-7

(51) Int. Cl. B29B 11/10

(52) U.S. Cl. 264/141

(57) ABSTRACT

A method of making a polymer/natural fiber composite pellet and/or a coupling agent/natural fiber pellet and the pellet made by the method. The pellet is intended to be used in molded structural composites comprising thermoplastic polymers and fibers. It is produced by carding or combing the natural fibers and to form a sliver or roving therefrom, which is combined with the polymer and/or coupling agent in a melted or dissolved state. The fibers may either be dispersed in the polymer through an extrusion process or be present as an inner core surrounded by an outer sheath of polymer and/or coupling agent.

### TECHNICAL FIELD

The present invention refers to a method of making a polymer/natural fiber composite pellet and/or a coupling agent/natural fiber pellet and the pellet made by the method. The pellet is intended to be used in molded structural composites comprising thermoplastic polymers and fibers.

### BACKGROUND OF THE INVENTION

Structural composites are used in a variety of applications that require plastic parts having certain minimum values of mechanical properties, such as strength and impact resistance. By combining thermoplastic or thermosetting polymers with fibers, structural composites can be formed, which have mechanical properties useful in for example furniture, interior fittings in cars, structural components etc. Glass fibers have been commonly used as reinforcing material in such composites, wherein the glass fibers and the polymer material are mixed together and formed into a composite part for example by compression molding and injection molding. Glass fibers however have certain drawbacks, such as abrasiveness, density, less environmentally friendly and give more residues when incinerated.

It is also known to use cellulose fibers, especially wood fibers in the form of saw dust and milling tailings, mixed with polymer material to form cellulosic/polymer composites, which combine many of the advantages of wood and plastic while avoiding the disadvantages of either material. The composite materials are manufactured by mixing the finely divided cellulosic material into the molten plastic. The plastic/cellulose-mixture is extruded through a die to form pellets which are sold as the basic material for manufacturing cellulosic/polymer structural composites.

Because of the polarity difference between the hydrophilic wood/cellulose component and the hydrophobic thermoplastic matrix resin these two components are incompatible and the wood/cellulose component will not disperse well in the polymer matrix. Therefore a coupling agent, which increases the compatibility between these two components, is often added. An example of a commonly used coupling agent is maleic anhydride.

U.S. Pat. No. 5,981,067 refers to a composite pellet comprising a thermoplastic polymer and a wood fibers, said pellets may be used to manufacture structural members. The thermoplastic polymer is a polyvinyl chloride polymer and the cellulosic fibers are modified by a reagent that can covalently bond to the cellulose hydroxyl and has a moiety that is compatible with the polymer. The wood fibers are for example in the form of sawdust.

U.S. Pat. No. 5,441,801 also discloses a wood fiber and polyvinyl chloride polymer pellet. The wood fibers are mainly in the form of sawdust and milling tailings.

U.S. Pat. No. 5,938,994 discloses an extrusion process for producing wood-plastic composite pellets. The preferred source of fibers is wood flour, wherein the fibers have a length between 0.01 and 0.90 mm.

U.S. Pat. No. 6,632,863 refers to a cellulose fiber/polyolefin pellet. Cellulose fibers and polyolefin material are mixed in a mixer and supplied to an extruder for extruding the pellets.

WO 2007/073218 refers to method for producing a composite material of natural fibers and plastic material. Loose, divided fibers or fiber bundles are conveyed in a dry or wet air stream and mixed with a thermoplastic binding agent. The fibers are formed into a solid or semi-solid product.

U.S. Pat. No. 7,052,640 discloses a moldable pellet based on the combination of synthetic cellulose fibres, such as Rayon and Lyocell, in yarn or tow form, and a sheath of thermoplastic polymer around the fiber yarn.

U.S. Pat. No. 5,595,696 relates to a fiber composite plastic produced from continuous fibers (endless fibers) rovings or from chopped fibers, and to a process for the preparation thereof. Natural fibers like sisal, flax and coconut fibers are also mentioned. Natural fibers have a definite length and are in this respect comparable with chopped fibers. The chopped fibers or natural fibers are fed via a conveyor into an extruder where they are mixed with polymer and additive and extruded to form pellets. Natural fibers tend to attach to each other and form lumps which cause problem in the feeding process and will remain as lumps in the pellets and effect the quality of the end product.

DE 10349110 refers to fibre strings (rovings) of banana fibres intended to be used for producing composite materials in which they are mixed with polymeric material. Banana fibres are long fibres (fibre lengths of some meters are mentioned in par. 11) and accordingly carding would riot be adapted for preparing such long fibres into rovings.

DE 19835983 describes the use of malefic anhydride for coating natural fibres before being combined with a thermoplastic material. The natural fibres are preferably jute. There is no disclosure of carding or combing the fibres and forming a sliver or roving therefrom before mixing the fibres with the thermoplastic material.

WO 96/05347 discloses a fiber-reinforced structure comprising a thermoplastic polymer and reinforcing fibrous substrate in the form of jute, kenaf, roselle, aramina and sunnhemp. These fibres a longer and coarser than cotton and cellulosic wood fibres and are usually not carded or combed. The fibres in the process disclosed in this document are mixed with unrnelted thermoplastic polymer.

WO 02/083824 refers to composite compositions comprising thermoplastic polymer and cellulosic fibers and lubricant/coupling agents for such compositions as well as methods to form structural members from the compositions. It is mentioned (page 13, lines 17-21) that the composition can be provided by “combing” the components disclosed in U.S. Pat. Nos. 3,943,079; 4,338,228; 5,886,066; and 5,997,784. However, a close inspection of these patents reveals that none of them refers to combing of the components, so it must be understood that the term combing refers to combining.

There is still room for improvements in the manufacture of polymer/natural fiber composite pellet, especially when using longer fibers as compared to saw dust and milling tailings. Even though higher length to diameter ratio of fibers is generally desired due to better reinforcement, the corresponding difficulties in mixing longer fibers into plastics have in general prevented rational manufacturing. Another general problem with long natural fibers is a higher tendency to agglomeration during mixing of the fibers with the hydrophobic polymer melt.

### SUMMARY OF THE INVENTION

An object of the present invention is to provide an effective process for manufacturing composite pellets of polymer material and natural fibers, and which is especially useful for natural fibers that are longer than the commonly used sawdust and milling tailings. In one aspect of the invention the process comprises the steps of: carding or combing the natural fibers and forming a sliver or roving of the fibers; combining the sliver or roving of natural fibers with the polymer in a molten or dissolved state; solidifying the polymer to form a pellet precursor and chopping or pelletizing the pellet precursor into a plurality of pellets.

Carding or combing is a process used for fibers of definite length and in which the fibers are aligned essentially parallel to each other to produce a bat of oriented fibers that can be formed into a sliver or roving. The sliver or roving of carded or combed fibers is easy to tear apart to form individual fibres or loose fibre bundles. It is easy to handle in a process and provides a rational and effective way for combining natural fibers of relatively long length with a polymer material to produce pellets there from.

According to one embodiment the polymer is a thermoplastic polymer and is introduced in an extruder, in which the polymer is melted, the sliver or roving of natural fibers is introduced into the extruder and the fibers are mixed with the polymer, the polymer and fibre mixture is extruded trough an extrusion die and the extruded mixture is chopped into pellets.

According to a further embodiment the natural fibers have an average length of at least 2 mm. Examples of suitable natural fibers are cotton, hemp, jute, flax, ramie, sisal and cellulosic wood fibers.

In one aspect of the invention the natural fibers are dried before being combined with the polymer to a moisture content of not more than 9% by weight, preferably not more than 7% by weight, as calculated on the total fibre weight.

In a further embodiment a coupling agent, which is adapted to increase the compatibility between the polymer and the natural fibres, is added. The coupling agent is preferably selected from, maleic anhydride, maleic anhydride modified polymer, compounds with mono- or multifunctional reactive nitrogen groups and silanes.

In a still further embodiment the coupling agent, possibly combined with a carrier medium and/or other additives, is formed into fibres, which are carded and formed to a sliver or roving. This sliver or roving of coupling agent may be introduced into the extruder either separate from or combined with the sliver or roving of natural fibres. This results in a selected and fixed ratio of coupling agent and fibre content.

In one aspect of the invention a mixture of coupling agent and a thermoplastic polymer, for example a polyolefin, is spun into fibres, which are carded and formed into said sliver or roving. One example of a suitable coupling agent is maleic anhydride.

In a further embodiment of the invention a sheath of molten or dissolved polymer is spread circumferentially around said sliver or roving of natural fibres, wherein the polymer is solidified to form a pellet precursor, which is chopped or pelletized into pellets.

In a still further embodiment the invention refers to a process for making a coupling agent/natural fibre composite pellet, said coupling agent being adapted to increase the compatibility between the natural fibres and a polymer material, said method comprising the steps of: carding or combing the natural fibres and forming a sliver or roving of the fibres, spreading a sheath of molten or dissolved coupling agent circumferentially around said sliver or roving of natural fibres, solidifying the coupling agent to form a pellet precursor and chopping or pelletizing said pellet precursor into a plurality of pellets.

The invention further refers to a pellet comprising natural fibres and a polymer material, said pellet having a length between 2 and 50 mm and a diameter between 2 and 10 mm, wherein it comprises an inner core of carded natural fibres formed into a sliver or roving and an outer sheath of said polymer material.

According to one embodiment the pellet further comprises a coupling agent adapted to increase the compatibility between the natural fibres and the polymer material

The polymer material is according to one aspect of the invention a thermoplastic polymer.

According to an alternative embodiment the invention refers to a pellet comprising natural fibres and a coupling agent adapted to increase the compatibility between the natural fibres and a polymer material, said pellet having a length between 2 and 50 mm and a diameter between 2 and 10 mm, wherein it comprises an inner core of carded natural fibres formed into a sliver or roving and an outer sheath of said coupling agent. A suitable example of coupling agent is maleic anhydride.

### DEFINITIONS

“Carding” refers to a brushing process in which the fibers are aligned essentially parallel to each other in the direction in which the machine produces the web (machine direction).

“Combing” refers to a method for preparing fibers for spinning by the use of combs having long metal teeth. Combing the fibers removes short fibers and arranges the fibers in a flat bundle with the fibers aligned essentially in the same direction.

“Sliver” is a long bundle of fibers created by carding or combing fibers, which are then drawn into long strips where the fibers are essentially in parallel.

“Roving” is a sliver that has been twisted.

### BRIEF DESCRIPTION OF THE DRAWINGS

FIG. 1 is a schematic partly broken perspective view of a composite pellet on an enlarged scale made according to one embodiment of the invention;

FIG. 2 illustrates schematically a process for making pellets according to FIG. 1;

FIG. 3 is a schematic partly broken perspective view of a composite pellet on an enlarged scale made according to a further embodiment of the invention, wherein the fibers are present as an inner core surrounded by an outer sheath.

FIG. 4 illustrates schematically a process for making pellets according to FIG. 3.

### DETAILED DESCRIPTION OF PREFERRED EMBODIMENTS

The invention refers to the manufacture of composite pellets of natural fibers and polymer and/or coupling agent. The pellets can subsequently be re-melted and optionally be mixed with additional polymer material and be extruded or injection molded to form structural members for use in many different applications as a substitute for wood, plastics metal, glass fiber reinforced plastic etc. For example the pellets may be used to make furniture, interior fittings in cars, profiles or other components made of such materials.

The natural fibers used in the present invention are of a sufficient length to make them suitable for carding or combing. A major fraction of the fibers should have a length of at least 2 mm, preferably at least 5 mm and more preferably at least 10 mm. A major fraction of the fibers should further have an aspect ratio, i.e. a length/diameter ratio, of at least 10:1, preferably at least 100:1.

Examples of natural fibers suitable for use are cotton, hemp, jute, flax, ramie, sisal and cellulosic wood fibres. Mixtures of different natural fibers may of course be used as well.

The polymer material used in the composite pellets can be of optional kind. Preferably they are thermoplastic and include all known types of thermoplastic polymers, for example polyolefins, such as polyethylene, polypropylene, and copolymers thereof, polystyrene polymers, polyesters, polylactides, and halogenated polymers such as polyvinyl chloride and others. Mixtures of polymers may of course also be used.

A coupling agent is usually added to increase the compatibility between the natural fibres and the polymer material. Examples of coupling agents are certain organic acids or anhydrides thereof, for example maleic acid, fumaric acid, phtalic acid, acrylic acid, methacrylic acid and their anhydrides. Maleic anhydride is a preferred coupling agent. Other examples of coupling agents are compounds comprising mono- or multifunctional reactive nitrogen groups, for example amines, imines, imides, lactames, nitrites, azides, imidazoles, amino acids, isonitriles and silanes.

The dimensions of the pellets may vary but their length is preferably between 2 and 50 mm and their diameter is preferably between 2 and 10 mm.

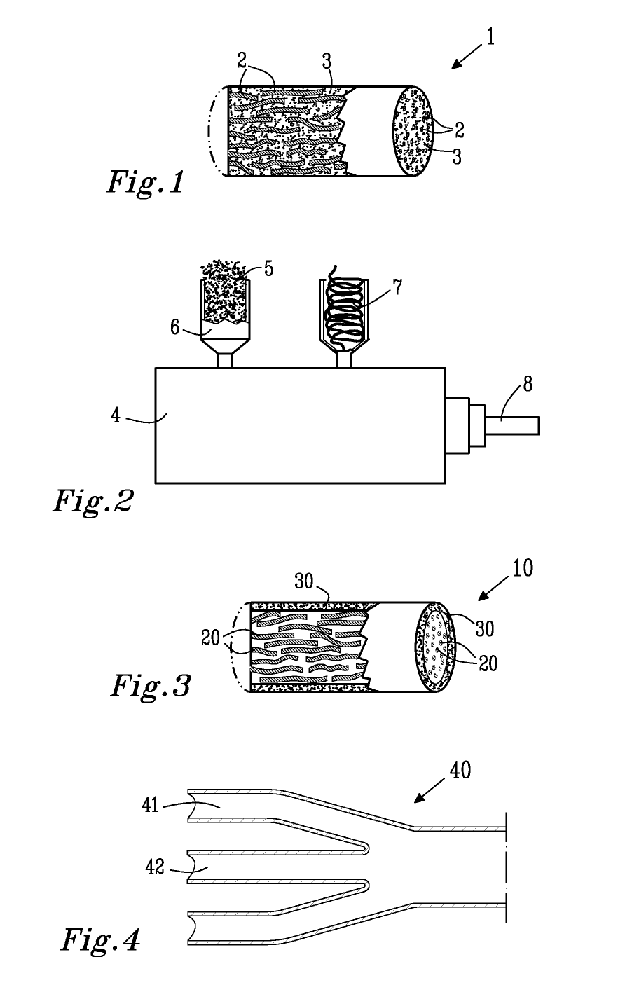

FIG. 1 shows on an enlarged scale a pellet 1 made by an extrusion process according to one embodiment of the invention. It comprises fibres 2 dispersed in a polymer matrix 3. Because of the extrusion process, which will be described below, a major fraction of the fibres 2 will be substantially oriented in the extrusion direction, i.e. along the major axis of the pellets.

The natural fibres are present in an amount of about 10 to 70% by weight as calculated on the total weight of the pellet. The rest is polymer material and optional additives like coupling agent. A suitable amount of coupling agent is between 3% and 10% by weight as calculated on the total weight of the pellet.

The extrusion process is schematically illustrated in FIG. 2, wherein the numeral 4 denotes an extruder, which may be of a conventional type used in plastics industry. The polymer material, which is in the form of for examples granules 5, is introduced in the extruder via a hopper 6. The polymer material is melted in the extruder by heating elements (not shown) and by the friction from a feeding screw (not shown). The fibres are introduced into the extruder in the form of a roving or sliver 7, either up-streams or down-streams of the polymer material. The roving or sliver has been formed from carded fibres. The sliver or roving preferably has a tex number between 1 and 30 g/1000 m. The sliver has a high degree of orientation of the fibres in the longitudinal direction of the sliver and has a continuous length of at least 1 meter up to several thousand meters. The sliver can be slightly twisted to form a roving having from 1 twist up to about 40 twists per meter. The sliver or roving should be able to be torn apart by hand to form individual fibres.

The natural fibres, which basically consist of cellulose, are preferably dried before being mixed with the polymer material in order to reduce the tendency for agglomeration and improve wettability. This will also improve the homogeneity and reinforcing effect. The drying may take place in any part of the process before mixing with the polymer. The moisture content after drying should preferably be not more than 9% by weight, preferably not more than 7% by weight, as calculated on the total weight of the fibres. The moisture content is measured after drying in an oven at 105° C. until a constant weight of the fibres is obtained.

The sliver or roving of natural fibres can either comprise only the natural fibres or a combination of natural fibres and fibres spun from a mixture of coupling agent and a polymer. The latter case will be described more in detail below.

The roving or sliver 7 of natural fibres is fed directly into the extruder 4 and is by the rotation of the feeding screw drawn down into the melting or already melted polymer material. The roving or sliver can either be introduced at the upstream end of the feeding screw or at any location along the screw to the downstream end thereof. Optionally two or more rovings or slivers may be introduced at different locations.

A coupling agent, such as maleic anhydride is also added to the extruder, either together with the polymer material 5 or with the roving or sliver 7 of fibres, or separate therefrom. The coupling agent may be added in the form granulate or in the form of fibres, which will be closer described below.

When the roving or sliver 7 is introduced into the extruder it is totally or partly torn apart to form individual fibres or fibre bundles, which are mixed with the melted polymer material. At the outlet end 8 of the extruder a mixture of fibres and melted polymer comes out as a continuous melted string with a diameter between 2 and 10 mm. This string solidifies after the outlet by being cooled by air transport or through a liquid bath, for example water bath. A conventional pelletizing equipment (not shown) is used to chop the continuous string into pellets or granulate. The length of the pellets is preferably between 2 and 50 mm.

The rotational speed of the feeding screw in the extruder may vary from 5 to 500 revolutions per minute. The temperature of the melted polymer may vary depending on the type of polymer used, but is usually in the range between 100 and 250° C.

It was mentioned above that the coupling agent may be added to the extruder 4 either as granulate or as fibres. In the latter case the coupling agent, for example maleic anhydride, mixed with a polymer, for example a polyolefin such as polyethylene or polypropylene, is spun into fibres. The amount of coupling agent in this mixture may vary from 5 to 95% by weight of the mixture. In one embodiment a copolymer of polypropylene and maleic anhydride (maleic anhydride grafted polypropylene) is used, said copolymer being mixed with pure polyolefin, for example polypropylene and the mixture is spun into fibres. Alternatively the polymer is excluded and the fibres are spun from a coupling agent only.

Staple fibres of a length from 5 to 100 mm are produced. The fibres are carded or combed and formed to a long continuous sliver, which is combined with a sliver of natural fibres, and twisted to form a roving as discussed above.

The amount of natural fibres in the combined sliver or roving may vary from 50 to 95% by weight of the total weight of the sliver and thus the amount of staple fibres produced from coupling agent and polymer can vary from 5 to 50% by weight of the sliver.

FIG. 3 shows a pellet 10 according to the invention made by an alternative process. The pellet 10 comprises an inner core 20 in the form of a sliver or roving of natural fibres of the same kind as discussed above, and surrounded by a sheath 30 of polymer material. The polymer material may be of the same kind as in the pellet of FIG. 1. Alternatively the sheath 30 is composed of coupling agent only, for example maleic anhydride, or a combination of polymer and coupling agent. It is pointed out that the drawings are very schematic and that in for example FIG. 3 the sheath 30 of polymer material surrounding the inner core 20 of fibers may penetrate in between the fibers.

The pellet 10 in FIG. 3 can be made by a sheathing technique similar to what is used for manufacturing sheathed electrical cables. A part of a sheathing tool 40 is schematically shown in FIG. 4. Melted polymer is introduced into the tool via conduits 41. The roving or sliver is introduced into the tool 40 via a central conduit 42, in a manner so that the melted polymer will form a sheath around the circumference of the roving. By directing the outlet of the tool 40 downwards the force of gravity, in combination with the pressure from the melted polymer, will contribute to feed the roving through the tool, where it is coated with a polymer coating.

Also in this process the natural fibres are preferably dried to moisture content of not more than 9% by weight, preferably not more than 7% by weight, as calculated on the total fibre weight, before being sheathed with the polymer.

As told above the polymer coating can be substituted for a coating of coupling agent or a combination of polymer and coupling agent. Alternatively a coupling agent is added to the sliver or roving in a manner described above with reference to the previous embodiment.

The pellets made according to the present invention are intended to be transported to a user where they are re-melted and in many cases mixed with additional polymer material and optional additives to produce structural members by injection moulding or extrusion. It is often desired to keep the content of fibres in the pellets as high as possible and the user can then mix with an appropriate amount of additional polymer.

The following example is provided for the purpose of further illustrating the present invention, and is not intended to limit the scope of the invention.

### Example

Polymer/natural fiber composite pellets were manufactured in a compounder. The resulting pellets were used for creating a shaped article in an injection molding process. The fibers in this example were cotton fibers. The cotton fibers were harvested, packed, transported, unpacked and cleaned by known methods for processing cotton for the textile industry. The fibers were carded, formed to a sliver and slightly stretched. The sliver was put into a can thereby naturally twisted half a revolution per meter.

The polymer used was polyethylene HYA 800 purchased from ExxonMobile. The coupling agent used was maleic anhydride G2608 purchased from Eastman. Both the polyethylene and the coupling agent were fed into a twin screw extruder (ZSK 25 WLE from Coperion Werner-Pfleider). The temperature profile was 185, 185, 190, 185, 185, 190, 190 degrees Celsius and the speed of the screw was 400 rpm. The fiber sliver was fed into the extruder through a side screw. The fiber fraction was approximately 13% by weight, and the coupling agent approximately 5% by weight. The duration of stay in the extruder was approximately 1 min. The composite material leaft the extruder in the form of a string and was directly fed into a bath of water for approximately 2 meters before being directly cut into 5 mm long pellets.

The pellets were dried before injection molding, and were then processed by known methods for injection molding at known conditions and at a temperature of 190 degrees Celsius.

1. A method of making a polymer/natural fibre composite pellet, comprising the steps of:
carding or combing the natural fibres and forming a sliver or roving of the fibres, combining the sliver or roving of natural fibres with the polymer in a molten or dissolved state;
solidifying the polymer to form a pellet precursor;
chopping or pelletizing the pellet precursor into a plurality of pellets.

2. The method as claimed in claim 1, characterized in that the polymer is a thermoplastic polymer and is introduced in an extruder, in which the polymer is melted, introducing the sliver or roving of natural fibres into the extruder and mixing the fibres with the polymer, extruding the polymer and fibre mixture trough an extrusion die and chopping the extruded mixture into pellets.

3. The method as claimed in claim 1 or 2, characterized in that the natural fibres have an average length of at least 2 mm.

4. The method as claimed in claim 3, characterized in that the natural fibres are chosen from: cotton, hemp, jute, flax, ramie, sisal and cellulosic wood fibres.

5. The method as claimed in any of the preceding claims, characterized in that the natural fibres are dried before being combined with the polymer, preferably to a moisture content of not more than 9% by weight, preferably not more than 7% by weight, as calculated on the total fibre weight.

6. The method as claimed in any of the preceding claims, characterized in adding a coupling agent which is adapted to increase the compatibility between the polymer and the natural fibres.

7. The method as claimed in claim 6, characterized in that said coupling agent is selected from, maleic anhydride, maleic anhydride modified polymer, compounds with mono- or multifunctional reactive nitrogen groups and silanes.

8. The method as claimed in claim 7, characterized in that said coupling agent possibly combined with a carrier medium and/or other additives is formed into fibres, which are carded and formed to a sliver or roving.

9. The method as claimed in claim 2 and 7, characterized in that said sliver or roving of coupling agent is introduced into the extruder either separate from or combined with the sliver or roving of natural fibres.

10. The method as claimed in claim 8 or 9, characterized in that a mixture of coupling agent and a thermoplastic polymer, for example a polyolefin, is spun into fibres, which are carded and formed into said sliver or roving.

11. The method as claimed in claim 10, characterized in that said coupling agent is maleic anhydride.

12. The method as claimed in any of claims 1 and 3-11, characterized in spreading a sheath of molten or dissolved polymer circumferentially around said sliver or roving of natural fibers, solidifying the polymer to form a pellet precursor and chopping or pelletizing said pellet precursor into a plurality of pellets.

13. A method of making a coupling agent/natural fiber composite pellet, said coupling agent being adapted to increase the compatibility between the natural fibers and a polymer material, said method comprising the steps of:
carding or combing the natural fibers and forming a sliver or roving of the fibers,
spreading a sheath of molten or dissolved coupling agent circumferentially around said sliver or roving of natural fibers, solidifying the coupling agent to form a pellet precursor and chopping or pelletizing said pellet precursor into a plurality of pellets.

14. The method as claimed in claim 13, characterized in that said natural fibers have an average length of at least 2 mm and are chosen from cotton, hemp, jute, flax, ramie, sisal and cellulosic wood fibers.

15. The method as claimed in claim 13 or 14, characterized in that said coupling agent is selected from, maleic anhydride, maleic anhydride modified polymer, compounds with mono- or multifunctional reactive nitrogen groups and silanes.

16. A pellet comprising natural fibers and a polymer material, said pellet having a length between 2 and 50 mm and a diameter between 2 and 10 mm, characterized in that it comprises an inner core (20) of carded natural fibers formed into a sliver or roving and an outer sheath (30) of said polymer material.

17. A pellet as claimed in claim 16, characterized in that it further comprises a coupling agent adapted to increase the compatibility between the natural fibers and the polymer material

18. A pellet as claimed in claim 16 or 17, characterized in that the polymer material is a thermoplastic polymer.

19. A pellet comprising natural fibers and a coupling agent adapted to increase the compatibility between the natural fibers and a polymer material, said pellet having a length between 2 and 50 mm and a diameter between 2 and 10 mm, characterized in that it comprises an inner core (20) of carded natural fibers formed into a sliver or roving and an outer sheath (30) of said coupling agent.

20. A pellet as claimed in claim 19, characterized in that the coupling agent is maleic anhydride.
